(19) United States
(12) Patent Application Publication
(10) Pub. No.: US 2025/0100630 A1
(43) Pub. Date: Mar. 27, 2025

(54) Extendable Cargo Space for a Container or Flatbed

(71) Applicant: Chris Onuschak, Jacksonville Beach, FL (US)

(72) Inventor: Chris Onuschak, Jacksonville Beach, FL (US)

(21) Appl. No.: 18/373,540

(22) Filed: Sep. 27, 2023

(51) Int. Cl. B62D 33/08

(52) U.S. Cl. CPC B62D 33/08

(57) ABSTRACT

Temporary additional cargo space is desirable when it is needed to deliver items on a temporary basis. The additional cargo space may be contained in a container or a flatbed. A means to move a second container or second planar surface on a flatbed is provided. The means to move the second container or second planar surface on a flatbed allows the user to have additional cargo space without the need to purchase a larger sized container or a larger sized flatbed.

### BACKGROUND OF THE INVENTION

### A. Field of the Invention

Trailers, which are attached to trucks, are often used by different professionals to tow various pieces of equipment or tools. These pieces of equipment may include lawn equipment, plumbing equipment, carpentry equipment, or may be used to pull a container full of goods. At times, it is desirable to have an extendable trailer platform for use on a temporary basis so that additional cargo items may be stored freely and easily such that the items can be moved from location to location without the necessity of obtaining a different length container of different length flatbed to accomplish the stated task.

The extendable trailer platform, which should be manufactured to support a significant amount of weight and withstand all environmental conditions is connected to the trailer that is used so that the individual can extend the length of the trailer easily and then lock the extendable platform in place. Wheels may be added to the extendable platform for additional support prior to transport. When the individual no longer needs the additional cargo space of the extendable trailer platform, the platform is pushed back towards the original trailer and stored in its original space. The extendable platform should be made from strong, durable materials, which can withstand all extremes of temperatures and all environments. A means to extend the expandable cargo space will be used to move the extendable platform; the expandable section may be extended in increments and locked in place to accommodate the specific needs of the user.

### PRIOR ART

There are many other prior art references to trailers and extendable trailers. A representative example of this type of device can be found at Jager, U.S. Pat. No. 6,378,893. The Jager reference, however, does not telescope, but extends the bed of a truck. Another reference is found in Damron, U.S. Pat. No. 6,983,953. This is an extendable trailer, but is limited to a very specific type of trailer: a lumber trailer. It employs a hydraulic boom to move the lumber off the ground, onto the trailer, and then reverse the process. However, the device is limited to a lumber truck.

Another representative example can be found in Gosselin, U.S. Pat. No. 8,136,850. The Gosselin references an extendable trailer having a roll board assembly. This device, however, does not telescope.

Another reference can be found in Patterson, U.S. Pat. No. 10,889,230. The Patterson device is an extendable compartment trailer assembly and method. The device is placed on the hitch of a car that will consist of boxes within boxes, that can be extended outward to create more space. It is not designed with any wheels on the device. It does teach, however, multiple compartments.

Another representative example can be found in Morena, U.S. Pat. No. 10,988,189. The Morena device is an extendable trailer for freight containers. The frame is mounted to a vehicle and the rear frame section is mountable above the rear wheel assembly. None of the prior art references teach all the features of this particular device or suggest the teaching of all the elements of this device.

### BRIEF DESCRIPTION OF THE INVENTION

This is a device to extend the body of a trailer on a temporary basis to provide additional cargo space. The platform on which to store items can be a metal grate or a solid piece of material. Regardless of the type of material that is selected, the material will need to be able to withstand all environmental conditions and be durable enough to support heavy loads. It is anticipated that there will be two embodiments: one with a container and one with a flatbed. Regardless of the type of space, the concept remains the same in either embodiment.

In the example of the first embodiment involving a container, the container is secured to a truck. The outer container has a defined shape with a solid top and solid bottom surfaces and solid surfaces on the sides of the container and an opening through which goods are stored. A separate second container structure will be placed within the interior of the container. This second container structure will provide a covered space to store additional cargo items and can be extended away from the outer container to provide additional storage area for equipment to be stowed. This separate second container will have a defined top, defined sidewalls, a defined bottom with an opening.

In the example of the container the separate second container structure may rest on rails within the container to track the movement of the separate second container structure as it is moved from the original container structure to form the additional cargo space. A means to move the separate container structure will be included and this means may include a pneumatic, hydraulic, electrical system or a gear and pulley system. No specific means to move the separate second container structure is anticipated by this application. A means to lock the separate container structure in place will also be provided.

In the second embodiment a flatbed will be used. The flatbed area of the truck has a defined bottom and defined sides but does not have a defined top surface. A second planar member will rest on the flatbed surface. When additional area is required, the second planar member is extended away from the truck to provide additional cargo area. This extendable portion will permit additional storage of equipment onto the second planar member surface. The second planar member may be moved back in increments and locked in place.

The means to extend the second planar member may include a hydraulic, pneumatic, electrical or gear and pulley system may be used; a set of rails may also be used to ensure that the second planar member extends uniformly. No specific means is being claimed in this application. A folding ramp system may also be provided to allow items to be easily placed on the extendable platform or removed from the extendable platform. Wheels may also be provided on the underside of the extendable second container or second planar member platform to provide additional support.

### BRIEF DESCRIPTION OF THE DRAWINGS

FIG. 1 is a side view of a box truck depicting the interior storage space in dashed lines for the extendable separate second container.

FIG. 2 is a side view of a box truck with the extendable separate second container with the telescoping drive train.

FIG. 3 is a rear view of the covered box truck depicting the extendable second container.

FIG. 4 is a perspective view of a box truck with the extendable second container in the collapsed position.

FIG. 5 is a perspective view of a box truck with the covered second container extended away from the body of the box truck.

FIG. 6 is a side view of a flat bed with the extendable second planar member in the collapsed position.

FIG. 7 is a side view of the flat bed with the extendable second planar member and extendable drive train in the extended position.

FIG. 8 is a rear view of the flat bed with the extendable second planar member in the collapsed position within the area of the flat bed.

FIG. 9 is a perspective view of a flat bed with the extendable second planar member positioned in the body of the flatbed area.

FIG. 10 is a perspective view of the flatbed with the extendable second planar member in the extended capacity.

### NUMBERING REFERENCE

1—Truck
5—Flatbed truck area
10—Extendable second planar member on the flat bed
15—First Container attached to the truck.
20—Second Container structure
25—Expandable drive train

### DETAILED DESCRIPTION OF THE EMBODIMENTS

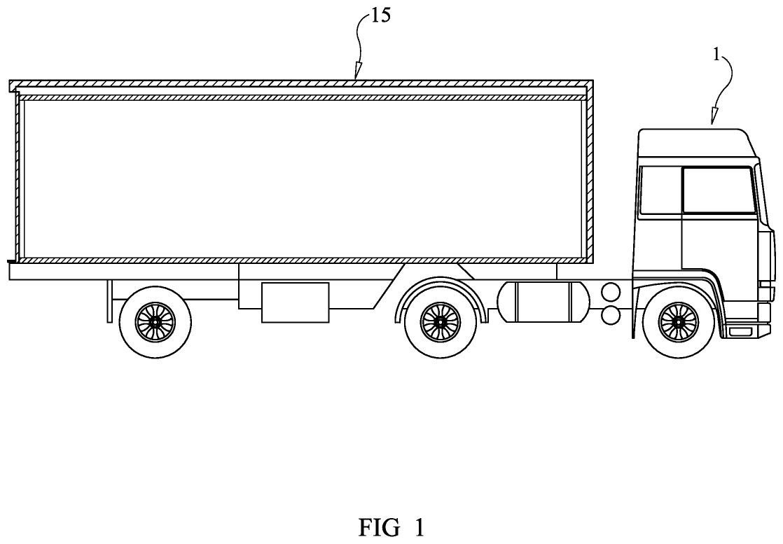

Trucks 1 such as the one depicted in FIG. 1 are used commonly to store and transport goods. The truck can be any shape or size including a full-length trailer or a trailer or a flatbed truck. The truck in FIG. 1 is simply a representation of a type of truck that is used to transport material. The material that is transported may be construction material, lawn maintenance equipment or items such as appliances that are transported in boxes as examples of the kinds of equipment or goods that may be transported.

In certain circumstances, it may be advisable to provide an additional platform surface for temporary use which may be necessary to haul additional equipment. The extendable cargo space is not intended to be used for other than temporary time periods. The platform or structure should be constructed of durable material that can withstand all extremes in temperatures and environmental conditions.

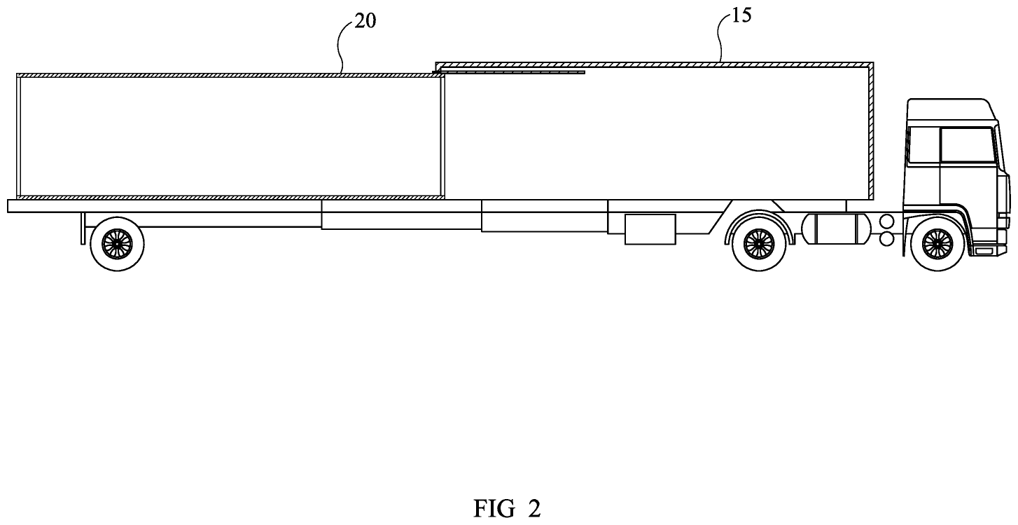

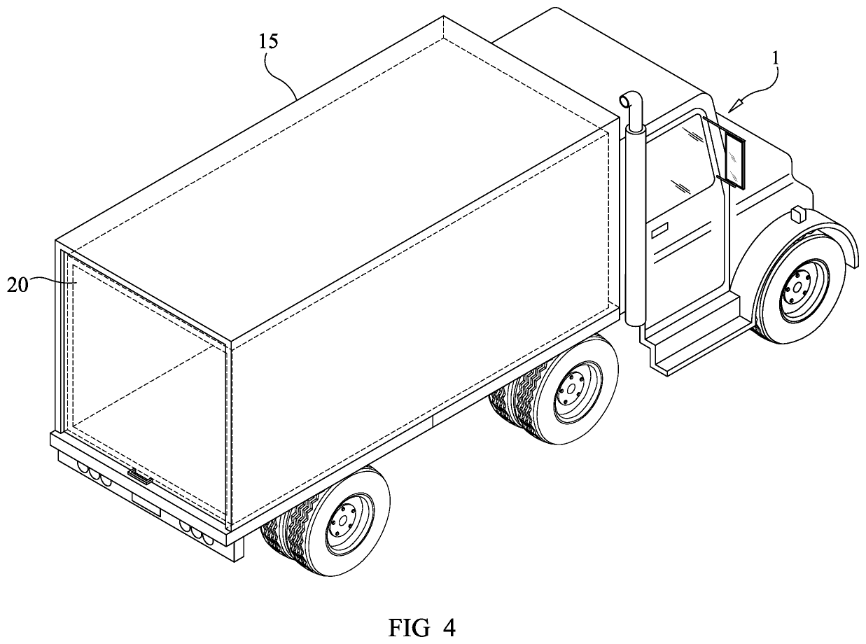

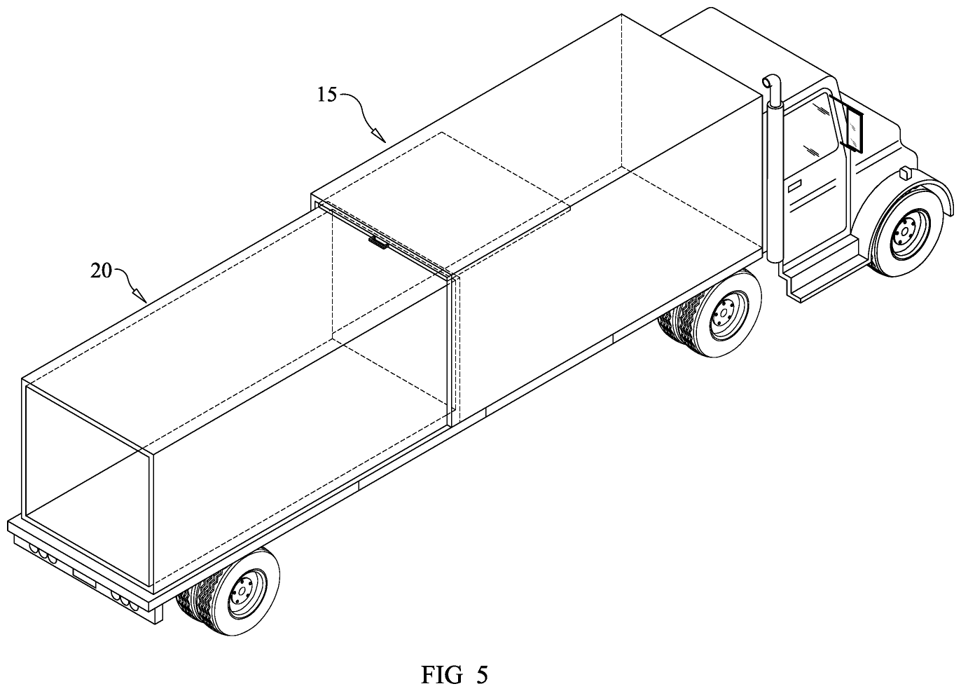

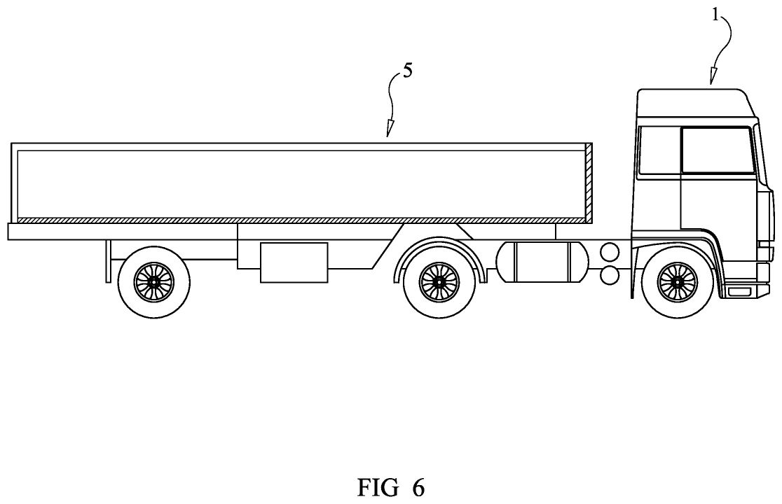

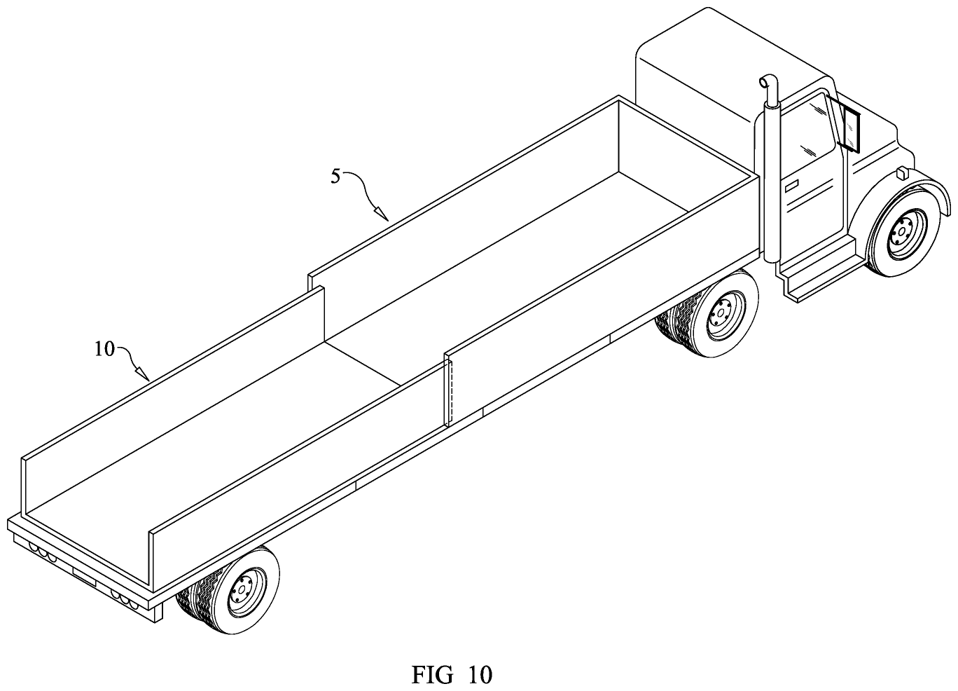

In this application there are two embodiments. The first of the embodiments is the use of a first container 15 that stores an additional second container space 20 with the first container such as depicted in FIGS. 1-5. This container space can be expanded such as depicted in FIG. 2 to provide the additional cargo space that may be required. The second embodiment uses a flatbed that has a defined bottom surface and defined side walls. In this embodiment a second planar member will be placed on top of he defined bottom surface to provide the additional cargo space. The second embodiment is depicted in FIGS. 6-10. The truck is not being claimed.

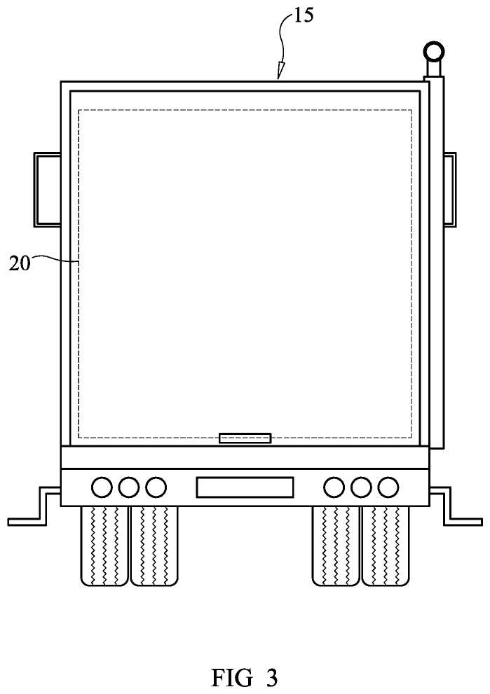

The first container 15 has defined sidewalls, as well as a defined top, a defined bottom and an opening into which goods are placed. Within the interior of the first container is an extendable or expandable second container, 20, which in normal situations will be enclosed within the container, such as depicted in FIG. 3. When additional storage space is necessary, the extendable second container 20 can be extended outward, away from the trucks such as depicted in FIG. 2. In order to accommodate this additional weight, it is anticipated that the drive train will be extendable as well. Additional wheels may also be provided for additional support.

There are many ways to extend the cargo space in either embodiment and no specific means is being claimed. Because of the amount of weight that is to be used, the means to extend the second container or second planar member is likely to be a device that will use either a hydraulic, pneumatic, or an electrical system. A gear and pulley system may also be used. No specific way to extend the second container or second planar member is being claimed.

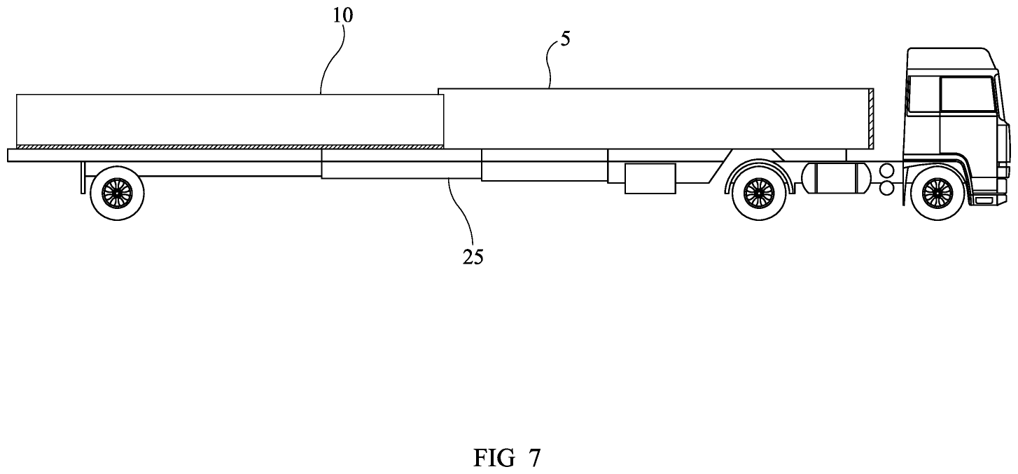

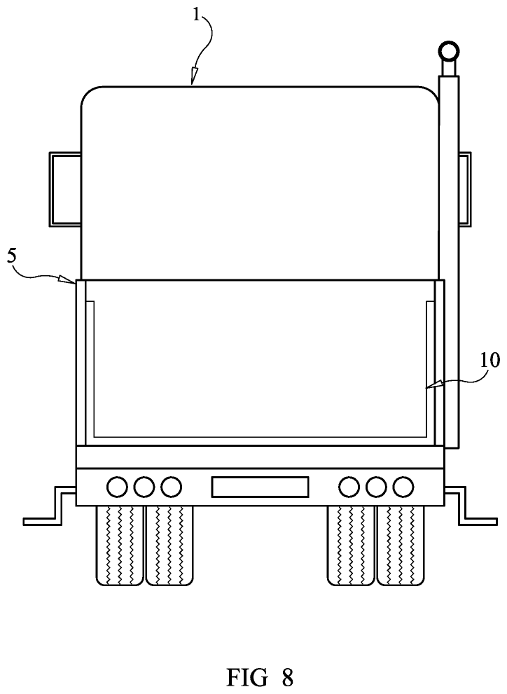

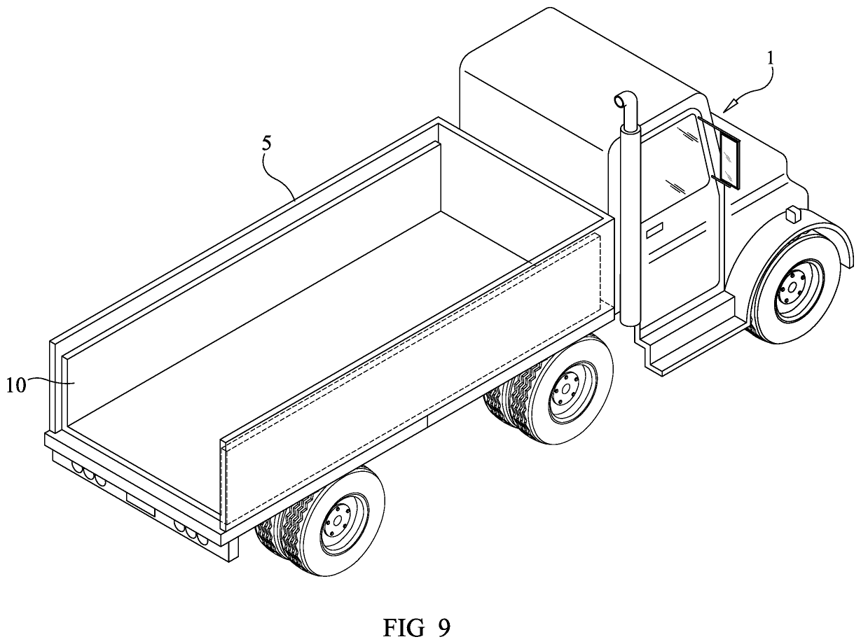

The second embodiment uses a flatbed and an extendable second planar member, such as depicted in FIG. 6. The extendable second planar member in normal use is positioned on top of the flatbed surface, such as depicted in FIGS. 8 and 9. If additional space is necessary, the extendable second planar member can be extended outward, away from the truck body, such as depicted in FIG. 7.

A means to lock (not depicted) the extendable second container or second planar member in place during transport will be provided. No particular means to lock the extendable platform in place is being claimed.

Wheels (not depicted) may be provided to provide additional support to the extendable second container or second planar member may be provided to provide additional support. A ramp (not depicted) may also be used to load or unload the cargo material onto the extendable platform and to unload material from the extendable platform.

While the embodiments of the invention have been disclosed, certain modifications may be made by those skilled in the art to modify the invention without departing from the spirit of the invention.

The inventor claims:

1. An extendable cargo space for a container, which is comprised of:
a first container,
said first container has a defined top, a defined bottom and defined side walls,
said first container has an opening to fill the container, a second container,
wherein the second container fits within the space of the first container,
wherein the second container has a defined top, a defined bottom and defined side walls,
wherein a pair of rails are placed within the first container,
wherein the second container is attached to the pair of rails,
wherein a means to move the second container is affixed to the second container,
wherein the second container is moveable, said rails guide the travel of the second container,
wherein the second container can be locked in place,
wherein a means to move the second container is provided,
an expandable drive train,
a ramp.

2. The extendable cargo space for a container as described in claim 1 wherein the means to move the second container is a hydraulic system.

3. The extendable cargo space for a container as described in claim 1 wherein the means to move the second container is an electrical system.

4. The extendable cargo space for a container as described in claim 1 wherein the means to move the second container is a pneumatic system.

5. The extendable cargo space for a container as described in claim 1 wherein the means to move the second container is a gear and pulley system.

6. An extendable cargo space for a flatbed, which is comprised of:
a flatbed,
wherein the flatbed has a first planar bottom surface, and defined sidewalls, a second planar member,
wherein the second planar member is positioned on top of the planar bottom surface of the flatbed,
a pair of rails,
wherein the pair of rails is secured to the first planar bottom surface,
wherein the second planar member is secured to the rails,
wherein the second planar member is moveable,
wherein the pair of rails guide the travel of the second planar member,
wherein the second planar member can be locked in place,
a means to move the second planar member,
wherein the means to move is affixed to the second planar member,
an expandable drive train,
a ramp.

7. The extendable cargo space for a flatbed as described in claim 1 wherein the means to move the second planar member is a hydraulic system.

8. The extendable cargo space for a flatbed as described in claim 1 wherein the means to move the second planar member is an electrical system.

9. The extendable cargo space for a flatbed as described in claim 1 wherein the means to move the second planar member is a pneumatic system.

10. The extendable cargo space for a flatbed as described in claim 1 wherein the means to move the second planar member is a gear and pulley system
